(19) United States
(12) Patent Application Publication
(10) Pub. No.: US 2018/0022072 A1
(43) Pub. Date: Jan. 25, 2018

(54) VEHICLE HEADLINER MATERIAL

(71) Applicant: Daehan Solution Co. , Ltd., Incheon (KR)

(72) Inventors: Choong Ho Kwon, Seoul (KR); Yungeun Gwak, Incheon (KR); SeokJun Yong, Incheon (KR); Sang-Min Kim, Incheon (KR)

(21) Appl. No.: 15/378,773

(22) Filed: Dec. 14, 2016

(30) Foreign Application Priority Data
Jul. 21, 2016 (KR) 10-2016-0092801

(51) Int. Cl. B32B 27/08; B32B 27/12; B60R 13/02; B32B 27/32; B32B 27/36; B32B 5/02; B32B 17/06; B32B 27/30

(52) U.S. Cl. CPC B32B 27/08; B32B 17/064; B32B 27/12; B32B 27/304; B32B 27/32; B32B 27/36; B32B 5/02; B60R 13/0212; B32B 2250/40; B32B 2250/05; B32B 2262/0284; B32B 2262/101; B32B 2262/106; B32B 2262/0261; B32B 2262/0246; B32B 2307/102; B32B 2307/7265; B32B 2307/546; B32B 2605/003; B32B 2605/08

(57) ABSTRACT

A vehicle headliner material includes a stiffening layer to prevent moisture penetration by reinforcing each side of a synthetic fiber layer. In this way, the synthetic fibers can be prevented from holding moisture, and thus safety accidents that may be caused by increased weight of the headliner material or permanent deforming of the headliner due to the headliner material that repeats holding and releasing moisture can be prevented. The vehicle headliner material is provided with improved formability, improved flexural strength, enhanced structural stiffness, and direct adhesion without an additional adhesive by including a synthetic resin in the synthetic fiber layer along with synthetic fibers and using a glass mat and thermoplastic resin sheets as constituent materials of each stiffening layer.

### CROSS-REFERENCE TO RELATED APPLICATION

This application claims priority to and the benefit of Korean Patent Application No. 10-2016-0092801, filed Jul. 21, 2016, the disclosure of which is incorporated herein by reference in its entirety.

### BACKGROUND

### 1. Field of the Invention

The described embodiments relate to a vehicle headliner material. More particularly, the described embodiments relate to a vehicle headliner material configured to have a synthetic fiber layer consisting of synthetic fibers that are vulnerable to moisture, and a stiffening layer on each side of the synthetic fiber layer, wherein the stiffening layer includes thermoplastic resin sheets responsible for adhesion and moisture blocking and a glass mat responsible for stiffness. In this case, the vehicle headliner material is light and exhibits excellent bending stiffness and improved moisture resistance. In particular, by preventing a phenomenon in which moisture in a headliner causes the headliner to become heavier or covered with mold or the like, the vehicle headliner material according to the described embodiments can contribute to maintaining a safe and pleasant interior environment of the vehicle.

### 2. Discussion of Related Art

A headliner (1) as illustrated in FIGS. 1 and 2 refers to an interior material installed in an interior of a vehicle in such a way that it faces a roof panel (R) to improve the appearance of the interior and reduce noise. Along with floor carpets, the headliner is one of important finishing materials used to reduce noise. Being installed over the heads of a driver and passengers, the headliner is configured to have a low overall weight to improve noise problems in a safe way. As described in Patent Documents 1 to 3 provided below, various materials are used to prepare such a headliner.

(Patent Document 1) Korean Patent No. 1198967

The document relates to a method of preparing a vehicle headliner by directly preheating a headliner material using an upper heat plate and a lower heat plate, instead of using a conventional method of indirectly preheating a headliner material using a ceramic oven. In this way, productivity can be improved because headliners of uniform quality can be produced in a shorter time.

(Patent Document 2) Korean Patent No. 1279522

The document relates to a method of preparing a natural-fiber reinforced composite board that can be used as a vehicle interior material, such as a headliner, by using thermoplastic matrix fibers, thermoplastic reinforced fibers, natural fibers, and the like. According to this method, problems related to low thermal stability of common thermoplastic matrix fibers, such as polypropylene fibers and core and sheath type composite fibers based on a low melting point polyester, are improved by improving degrees of crystallinity and adhesion of thermoplastic matrix fibers. In this case, the natural-fiber reinforced composite board that has been developed as thus serves as a reliable vehicle interior material.

(Patent Document 3) Korean Patent No. 1383780

The document relates to a method of preparing a vehicle headliner by way of directly preheating a headliner material using an upper heat plate and a lower heat plate, which are set at mutually different temperatures, instead of using a conventional method of indirectly preheating a headliner material using a ceramic oven. In this way, not only can productivity be improved because headliners of uniform quality can be produced in a shorter time, but also an acoustic absorptivity of the headliner can be enhanced, and thus interior noise of the vehicle is reduced and a pleasant environment is provided for the user.

However, the conventional headliner material including a fiber material such as a natural fiber or a synthetic fiber has the following problems. Here, a headliner may consist of a single headliner material (1′) as shown in FIG. 3 or a multiple layer structure built on a headliner material.

(1) Fibers can be used to prepare a headliner that is effective for reducing noise, e.g. by absorbing noise, and is lighter. However, when exposed to moisture, the natural fibers tend to absorb moisture, thus adding weight to the headliner material and degrading a noise dampening performance.

(2) Upon absorbing moisture, the headliner material becomes heavier, and the headliner consisting of the headliner material may sag and eventually deform or fall onto a floor of the vehicle. In the case of the vehicle being occupied, an injury to a driver and/or a passenger(s) may result.

(3) In particular, the headliner material deforms as the fibers repeat holding and releasing moisture, and may eventually become contorted or permanently deformed. Such deforming may degrade the performance and appearance of the headliner and lead to a safety accident.

(4) In addition, fibers holding moisture create an environment prone to mold and the like, and, due to decomposition of the fibers or the proliferation of molds that results in an unpleasant smell spreading throughout the vehicle, serve as a factor that makes the interior environment less pleasant.

### CONVENTIONAL ART DOCUMENTS

### Patent Documents

(Patent Document 1) Korean Patent No. 1198967 (Registered on Nov. 1, 2012)

(Patent Document 2) Korean Patent No. 1279522 (Registered on Jun. 21, 2013)

(Patent Document 3) Korean Patent No. 1383780 (Registered on Apr. 3, 2014)

### SUMMARY OF THE INVENTION

In consideration of the aforementioned problems, the described embodiments are directed to providing a vehicle headliner material that includes a stiffening layer to prevent moisture penetration by reinforcing each side of a synthetic-fiber-including layer. In this way, the synthetic fibers can be prevented from holding moisture, and thus safety accidents that may be caused by increased weight of the headliner material or permanent deforming of the headliner due to the headliner material repeating holding and releasing moisture can be prevented.

Also, the described embodiments are directed to providing a vehicle headliner material with further improved formability, further improved flexural strength, and direct adhesion without an additional adhesive or the like by using synthetic fibers and a glass mat that constitute a part of each stiffening layer to reinforce structural stiffness of the material and disposing a thermoplastic resin sheet on each side of each glass mat.

In order to fulfill the above objectives, the described embodiments provide a vehicle headliner material that includes a synthetic fiber layer prepared using synthetic fibers; and a stiffening layer disposed on each side of the synthetic fiber layer, wherein each stiffening layer includes a glass mat as a middle layer and a thermoplastic resin sheet on each side of the glass mat.

In particular, the synthetic fiber layer may have a thickness of 1 to 3 mm and an areal density of 500 to 600 g/m². In this case, the synthetic fiber layer may be prepared using at least one selected from the group consisting of polyethylene terephthalate (PET), glass fibers, carbon fibers, nylon, polyesters, and acrylics.

Also, the stiffening layer may have a thickness of 1 to 2 mm and an areal density of 100 to 500 g/m².

In addition, the glass mat may have an areal density of 50 to 200 g/m².

Also, the thermoplastic resin sheet may have a thickness of 20 to 250 μm.

Meanwhile, the thermoplastic resin sheet may consist of at least one selected from the group consisting of polyvinyl chloride (PVC), PS, polypropylene (PP), PE, and PET.

The headliner material according to the described embodiments may have an overall thickness of 2 to 5 mm and an areal density of 1,300 to 1,400 g/m².

The vehicle headliner material according to the described embodiments has the following effects:

(1) As a stiffening layer is disposed on each side of the synthetic fiber layer that is prone to moisture absorption, moisture absorption into the synthetic fibers can be prevented.

(2) In this way, deforming of the headliner material is prevented, which is caused by repeated moisture absorption and release by the synthetic fibers, resulting in degraded performance of the headliner material as a finishing material by eventually leading to being permanently deformed.

(3) Also, by preventing a phenomenon in which synthetic fibers hold moisture for a prolonged period of time in humid weather such as during a rainy season, the headliner material according to the described embodiments can prevent safety accidents that may be caused by increased weight of a headliner holding moisture.

(4) Meanwhile, since each stiffening layer is configured with a glass mat and thermoplastic resin sheets, the structural stiffness of the headliner material is reinforced. Also, as it is not required to use an additional adhesive, the headliner material can be prepared easily, safety accidents that may be caused by the use of an adhesive can be prevented, and working environments can be improved.

(5) In particular, since each thermoplastic resin sheet provides adhesion, use of an adhesive, such as a glue, to provide adhesion in a conventional manner is not necessary. Not only does this make the preparation of the vehicle headliner material more convenient, safer, and capable of being completed in fewer steps, it can also reduce bronchial system health risks for workers due to glue smell or the like, and reduce vehicle passenger health risks by eliminating adhesive smell when conventional headliner materials are installed in a vehicle.

### BRIEF DESCRIPTION OF THE DRAWINGS

The above and other objects, features and advantages of the described embodiments will become more apparent to those of ordinary skill in the art by describing in detail exemplary embodiments thereof with reference to the accompanying drawings, in which:

FIG. 1 is a perspective view of a vehicle for showing a position of a headliner installed in the vehicle;

FIG. 2 is a top plan view for illustrating the entire shape of a conventional headliner;

FIG. 3 is a cross-sectional view for illustrating a layer structure of a material for a conventional headliner; and

FIG. 4 is a cross-sectional view for illustrating a layer structure of a headliner material according to the described embodiments.

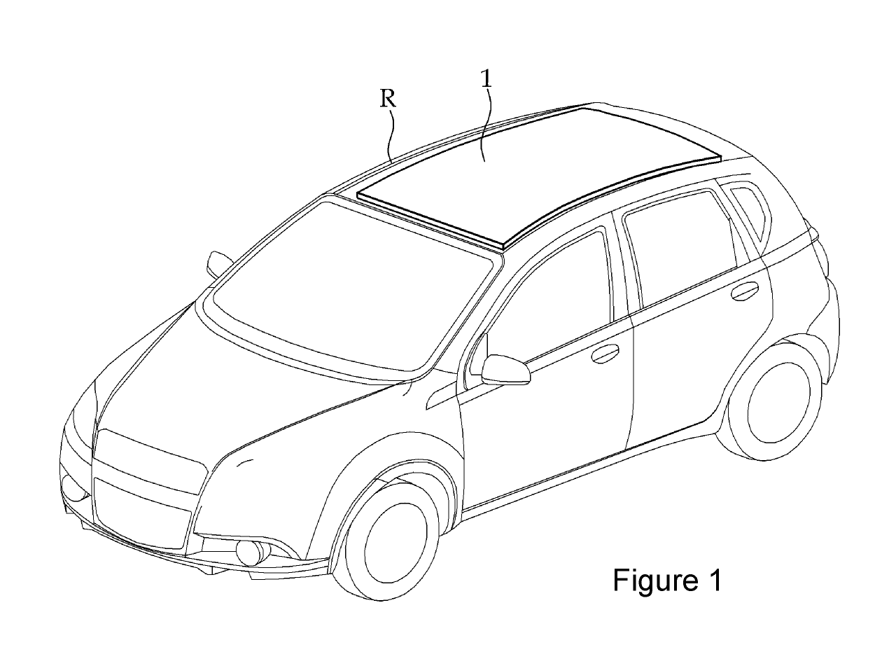

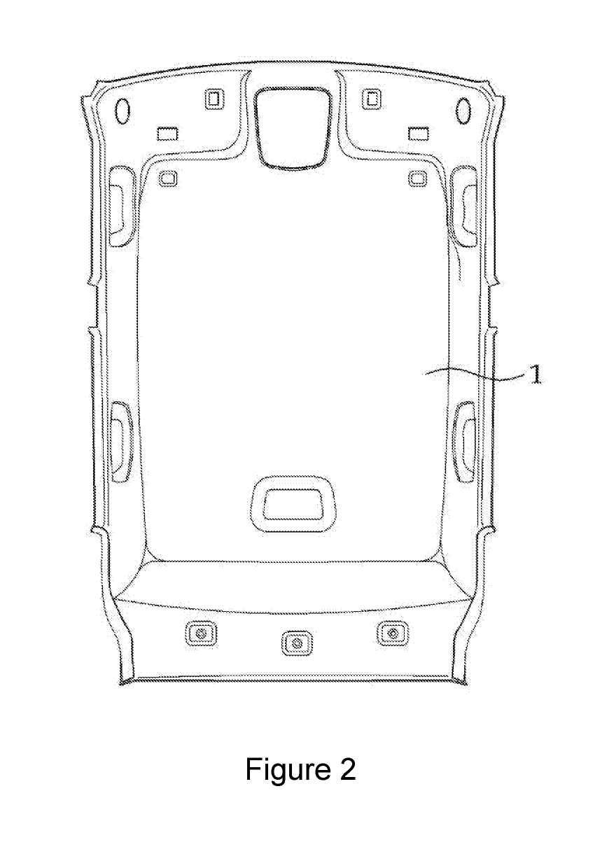

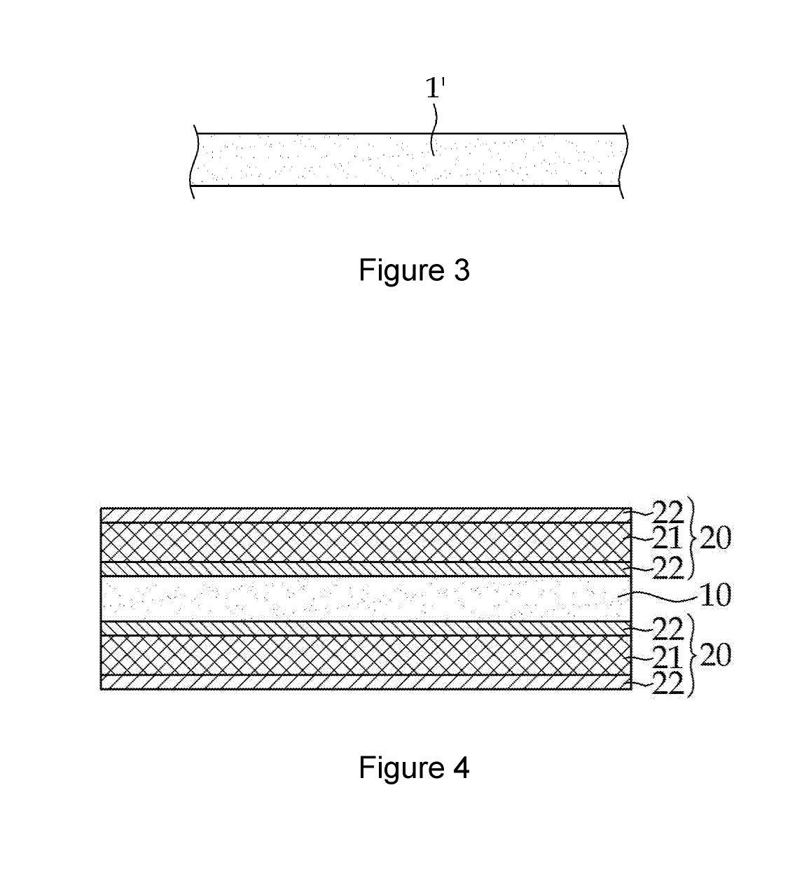

### DETAILED DESCRIPTION OF EXEMPLARY EMBODIMENTS

Hereinafter, exemplary embodiments of the present invention will be described in more detail with reference to accompanying drawings. Moreover, terms and words used in this specification and claims should not be interpreted as being limited to commonly used meanings or meanings in dictionaries and should be interpreted with meanings and concepts which are consistent with the technological scope of the described embodiments based on the principle that the inventors may appropriately define concepts of terms in order to describe the invention in the best way.

Therefore, since the embodiments described in this specification and configurations illustrated in drawings are only exemplary embodiments and do not represent the entire technological scope of the invention, it is understood that the described embodiments cover various equivalents, modifications, and substitutions at the time of filing of this application.

(Configuration)

As shown in FIG. 4, the vehicle headliner material according to an exemplary embodiment includes a synthetic fiber layer 10, and a stiffening layer 20 attached to each side of the synthetic fiber layer 10.

In particular, the stiffening layer 20 is configured to hinder moisture penetration into the synthetic fiber layer 10 so that synthetic fibers constituting the synthetic fiber layer 10 cannot hold moisture such as water. In this way, deforming of the headliner material that may be caused by repeated moisture absorption and release and safety accidents that may be caused by increased weight of a headliner material due to holding moisture can be prevented.

In addition, the stiffening layer 20 is configured to include the glass mat 21 to improve formability and structural stiffness of the headliner material to eventually enhance bending stiffness while enabling the formation of a headliner into a complex shape. Also, the thermoplastic resin sheet 22 included in the headliner material provides adhesion for gluing the synthetic fiber layer 10 and stiffening layer 20 together without using an additional adhesive.

Hereinafter, the configuration of the headliner material will be described in more detail. Here, the headliner material according to the exemplary embodiment may be one among many layers constituting a layer structure of a headliner, or the headliner material itself may represent the entire layer structure of a headliner.

The synthetic fiber layer 10 as shown in FIG. 4 refers to a layer of synthetic fibers prepared into a sheet form to enhance noise dampening performance of a headliner and for making a lighter headliner material.

In particular, it is preferable that the synthetic fiber layer 10 be prepared by gluing synthetic fibers together by using a synthetic resin. This is because when a layer prepared only with synthetic fibers is used as a part of a headliner material, while the headliner material may be light and have improved noise dampening performance, the headliner material may have insufficient bending stiffness and structural stiffness as a finishing material to be installed to face a roof panel in an interior of a vehicle. When a headliner material does not have sufficient bending stiffness and structural stiffness, there is a risk that a headliner that consists of the headliner material and is installed in an interior of a vehicle may sag or be contorted and eventually fall to the floor of the vehicle.

In consideration of noise dampening performance and weight increase, the synthetic fiber layer 10 is preferably configured to have a thickness of 1 to 3 mm and an areal density of 500 to 600 g/m². Also, any synthetic fiber may be used to prepare the synthetic fiber layer 10. For example, the synthetic fiber layer 10 may be prepared using at least one selected from the group consisting of polyethylene terephthalate (PET), glass fibers, carbon fibers, nylon, polyesters, and acrylics.

The stiffening layer 20 as shown in FIG. 4 is disposed on each side of the above synthetic fiber layer 10 to prevent moisture or the like from entering the synthetic fiber layer 10 and is configured for gluing layers together as a single entity. For this purpose, each stiffening layer 20 is prepared by attaching a thermoplastic resin sheet 22 to each side of a glass mat 21.

In this case, the glass mat 21 has good formability and can be easily shaped into a complex shape. In particular, the glass mat 21 provides stiffness to the headliner material of the exemplary embodiment to enhance flexural strength of the headliner material so that the headliner does not easily sag or deform. For sufficient bending stiffness and to minimize weight increase, it is preferable that the glass mat 21 is configured to have an areal density of 50 to 200 g/m².

The thermoplastic resin sheet 22 as shown in FIG. 4 is attached to each side of each glass mat 21 to provide adhesion and prevent moisture penetration when a stiffening layer 20 is bonded to a synthetic fiber layer 10.

Any thermoplastic resin that serves as an adhesive may be used to prepare the thermoplastic resin sheet 22. For example, at least one selected from the group consisting of polyvinyl chloride (PVC), PS, polypropylene (PP), PE, and PET may be used as the thermoplastic resin.

In particular, for using the thermoplastic resin sheet 22 as an adhesive component, it is preferable that the thermoplastic resin sheet 22 be prepared with minimum possible thickness that can promote adhesion between the synthetic fiber layer 10 and stiffening layer 20. For this purpose, the thermoplastic resin sheet 22 is preferably configured to have a thickness of 20 to 250 μm.

Meanwhile, the stiffening layer 20 of the exemplary embodiment prepared as thus is preferably disposed on each side of the synthetic fiber layer 10 as shown in FIG. 4. Also, the stiffening layer 20 is preferably prepared with minimum possible thickness and weight to prevent moisture from entering the synthetic fiber layer 10, and to promote adhesion with the synthetic fiber layer 10 while not adding too much weight to the headliner material. Therefore, the stiffening layer 20 is preferably configured to have a thickness of 1 to 2 mm and an areal density of 100 to 500 g/m².

In addition, the headliner material according to the exemplary embodiment is preferably configured to have a thickness of 2 to 5 mm and an areal density of 1,300 to 1,400 g/m² to minimize moisture penetration while minimizing weight of the headliner material itself at the same time. In this case, the headliner material is preferably configured to have a flexural strength of 1.95 to 2.35 kg/cm².

As described above, the headliner material of the described embodiments includes a stiffening layer for reinforcement on each side of a synthetic fiber layer, which includes synthetic fibers, to prevent moisture penetration into the synthetic fibers. In this way, problems that may be caused by deforming of the headliner material due to repeated moisture absorption and release and weight increase due to moisture absorption can be avoided.

Also, by including a glass mat and thermoplastic resin sheets in each stiffening layer, the headliner material of the described embodiments can attain improved bending stiffness and be adhered without requiring an additional adhesive.

### DESCRIPTION OF SYMBOL

10: SYNTHETIC FIBER LAYER
20: STIFFENING LAYER
21: GLASS MAT
22: THERMOPLASTIC RESIN SHEET

What is claimed is:

1. A material for a vehicle headliner, the material comprising:
a synthetic fiber layer prepared with synthetic fibers; and
a stiffening layer disposed on each side of the synthetic fiber layer,
wherein each stiffening layer includes:
a glass mat as a middle layer; and
a thermoplastic resin sheet on each side of the glass mat.

2. The material according to claim 1, wherein the synthetic fiber layer has a thickness of 1 to 3 mm and an areal density of 500 to 600 g/m².

3. The material according to claim 1, wherein the synthetic fiber layer is prepared using at least one selected from the group consisting of polyethylene terephthalate (PET), glass fibers, carbon fibers, nylon, polyesters, and acrylics.

4. The material according to claim 1, wherein the stiffening layer has a thickness of 1 to 2 mm and an areal density of 100 to 500 g/m².

5. The material according to claim 1, wherein the glass mat has an areal density of 50 to 200 g/m².

6. The material according to claim 1, wherein the thermoplastic resin sheet has a thickness of 20 to 250 μm.

7. The material according to claim 1, wherein the thermoplastic resin sheet consists of at least one selected from the group consisting of polyvinyl chloride (PVC), PS, polypropylene (PP), PE, and PET.

8. The material according to claim 1, wherein the material has an overall thickness of 2 to 5 mm and an areal density of 1,300 to 1,400 g/m².
